(19) United States
(12) Patent Application Publication
(10) Pub. No.: US 2006/0271851 A1
(43) Pub. Date: Nov. 30, 2006

(54) Computer application with streamlined formatting

(75) Inventors: Dean Anthony Racovolis, Redmond, WA (US); Steven Harris Mitchell, Tumwater, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/139,885

(22) Filed: May 27, 2005

(51) Int. Cl. G06F 17/00

(52) U.S. Cl. 715/530; 715/517

(57) ABSTRACT

A data processing application that operates in a constrained formatting mode in which formatting choices for one or more constructs are constrained. An example is provided in which the data processing application is a word processor and the construct is an outline numbered list. The formatting options available in the constrained mode of operation are specified in an artifact associated with the data processing application. Automatic formatting is applied consistently with the limited number of formatting choices. The same artifact may be associated with multiple copies of the data processing application, which ensures users within an enterprise use consistent formatting. In addition to generating more consistent documents, constraining formatting options across an enterprise reduces the possibility that automatic formatting functions generate documents with incorrect formatting as documents, and portions of documents, are shared by individuals within the enterprise.

### BACKGROUND OF INVENTION

1. Field of Invention

This invention relates generally to computer applications, such as word processors, and more particularly to improved usability of computer applications.

2. Discussion of Related Art

Computer applications are widely used in both a business and home setting. One important computer applications is a word processor, which allows a user to create letters, reports, presentations and other text based documents. MICROSOFT® WORD® word processor is an example of such a computer application.

Word processors are often very flexible so that a user may create documents with any desired appearance. Word processors traditionally allow a user to specify the format of constructs, such as characters, paragraphs or other blocks of text in a document. Formatting commands are specified by a user as the user works with the word processor to control formatting aspects of these constructs, such as font, font size or line spacing. Often, multiple user interfaces are available through which a user may provide format commands, including dialog boxes, menus or keystroke command interfaces.

While the ability to specify formatting for each construct in the document provides great flexibility, having to specify formatting of every construct would be very time consuming. To aid a user specify formatting, word processors often provide features that reduce the number of formatting commands a user must specify while processing a document. For example, a set of formatting commands may be stored as a template and then applied to constructs in a document as it is being created or edited. The MICROSOFT® WORD® word processor uses a template called “normal.dot” that stores formatting information that may be applied as new constructs are added or edited in the document being processed. These settings are applied unless the user provides other commands.

As a further aid to a user, the MICROSOFT® WORD® word processor also allows a user to specify “styles.” Each style also contains formatting command information. In use, a user enters commands that associate a particular style with a region of the document being processed. As the user provides text associated with that region of the document, the text will be formatted as specified by the applied style. If the formatting in the style is changed, the formatting of all sections with which that style has been associated will also change.

As a further aid to a user, the MICROSOFT® WORD® word processor includes components that execute to automatically apply formatting to constructs as they are incorporated into a document. When an auto formatting option is enabled, the auto formatting component examines text as it is input into the word processor and attempts to recognize a construct for which specific formatting is desired by the user. For example, the user may input text for the salutation of a letter. The auto formatting component may recognize the text as the salutation of a letter and apply formatting to the document consistent with a letter. As another example, auto formatting may recognize that the user is inputting text that represents items in a list. The auto formatting component may then apply indenting and paragraph numbering appropriate for a list.

Allowing formatting to be specified in multiple ways, though desirable because of the flexibility it provides, can sometimes yield undesired results. As an example, formatting of lists that use an outline numbering format presents particular complexities for applications that allow formatting to be specified in multiple ways, such as through a template, a style or through user inputs. Inconsistent formatting may be specified, which can result in lists not appearing as intended by a user. Such a problem can occur, for example, when lists are cut and pasted from different documents or different locations within the same document.

To illustrate a problem that can arise, FIG. 1 shows a document 110 and a document 112, each containing lists with multiple elements that are being processed by a word processor. A user may desire to combine the two lists by copying the list from document 112 and inserting the entire list in place of the first element in the list in document 110.

The lists have different formatting. The list in document 110 uses an outline numbering format in which each list element at a first level is identified with an arabic numeral and each sublist element at the second level is indented and identified with a lower case letter. In contrast, the list in document 112 uses an outline numbering formation with an indent and a second level of arabic numerals to identify sublist elements. The indent in the list in document 112 is less than the indent in the list of document 110.

When the list from document 112 is copied and pasted over the first element of the list in document 110, a list as shown in document 110′ may result. The combined list in document 110′ does not have consistent formatting. The sublist elements that were associated with the list in document 112 continue to be identified at the second level with arabic numerals while the sublist elements that were a portion of the list in document 110 continue to be identified by lower case letters.

The list in document 110′ is unlikely to be in the format that the user desires. However, inconsistent formatting associated with the list in document 110 and the list from document 112 makes it difficult, and in some cases impossible, for components in the word processor to identify and apply the desired formatting. As a result, a user may need to manually specify formatting commands for the merged list shown in document 110′. The need for such formatting can be time consuming and a source of frustration for users of computer applications.

### SUMMARY OF INVENTION

In one aspect, the invention relates to a computer application that has at least two modes of operation. In one mode of operation, a user has significant flexibility in specifying formatting. In another mode of operation, some or all of the flexibility is constrained.

In one aspect, the invention relates to a computer-readable medium having computer-executable components. A first component receives input from a user. A second component recognizes a construct in the input from the user. A third component applies formatting to the construct. The third component is operable in a first mode in which formatting is applied by automatically selecting a formatting rule from a plurality of sources and in a second mode in which formatting is applied by selecting a default formatting rule despite formatting rules specified in the plurality of sources.

In a further aspect, the invention relates to a graphical user interface including a display and a user input device in a computer system. The computer system executes a data processing application that operates on an artifact having one or more blocks of text. The graphical user interface can receive a user format request input. In a first mode of operation, in response to the user format request input, a plurality of formatting options are displayed. A user selection input indicating one of the plurality of formatting options is received and a block of text is formatted according to the indicated formatting option. In a second mode of operation, in response to the user format request input, a first of the plurality of formatting options is displayed with an indication that it is the default formatting option. A block of text is formatted according to the first of the plurality of formatting option.

In yet a further aspect, the invention relates to an enterprise data processing system. The system comprises a plurality of work stations, each having an associated document and an associated work station formatting template. A data store holds an enterprise-wide formatting template. A network connects each of the plurality of work stations to the data store. For each of the plurality of work stations, the system includes at least one data processing application program executable from the work station. The data processing application comprises a component for applying formatting to at least one construct in the associated document according to a formatting specified in the enterprise-wide formatting template when the data processing application program operates in a first mode or the associated work station formatting template when the data processing application operates in a second mode.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a series of screen shots illustrating an editing process performed with prior art word processor;

FIG. 2 is a screen shot illustrating a result of the editing process of FIG. 1 performed with a word processor according to an embodiment of the invention;

FIG. 3 is a screen shot illustrating a user interface for providing formatting command inputs in a prior art word processor;

FIG. 4 is a screen shot illustrating a user interface for providing formatting command inputs according to an embodiment of the invention;

FIG. 5 is a block diagram illustrating the architecture of a prior art word processor;

FIG. 6 is a block diagram illustrating the architecture of a word processor according to an embodiment of the invention; and

FIG. 7 is a block diagram of an enterprise employing a computer application according to an embodiment of the invention.

### DETAILED DESCRIPTION

A user's experience in using a computer application in which formatting may be specified is improved with a computer application that more accurately automatically applies desired formatting to constructs as a document is created or edited. In the description that follows, a word processor will be used as an example of a computer application in which formatting may be specified. However improvements in automatic formatting of documents may be employed with other applications, such as spread sheets and programs designed for creating presentations.

One construct in which inconsistent formatting specifications can arise is lists—particularly those that are outline numbered. In the description that follows, outline numbered lists are used as an example of a construct to which automatic formatting may be applied. However, the invention may be applied in connection with other constructs, such as section headings or document footers.

In one embodiment, automatic formatting is improved by providing multiple modes of operation of the computer application. In one mode, a wide range of formatting options is available to the user. In a second mode, the number of formatting options is limited. The limits may apply either to the formatting options that may be specified by the user or to the number of formatting options that will be automatically applied by the application. In one embodiment, both the number of formatting options that may be specified and the number of formatting options that will be automatically applied by the application are limited. Formatting options may be limited in multiple ways, such as by disabling portions of the word processor that provide formatting functions, masking or blocking those portions so that they cannot be accessed or removing those portions. The foregoing and other ways of limiting formatting options are herein referred to generally as “constraining” the formatting options.

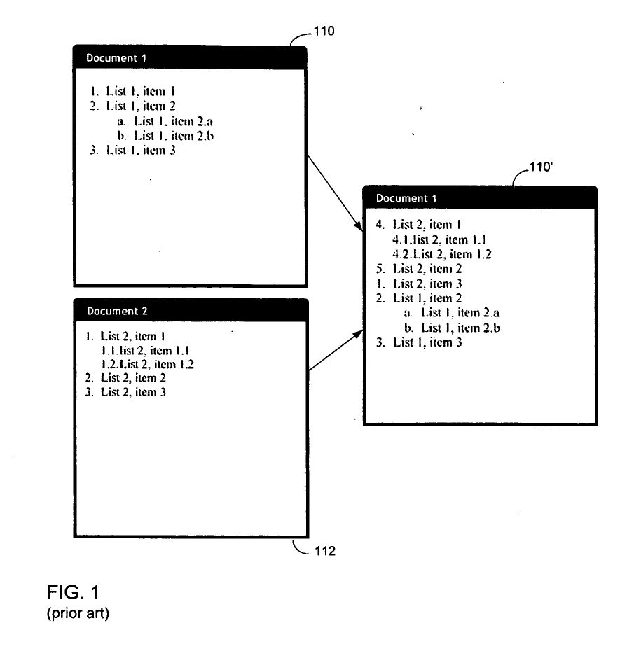

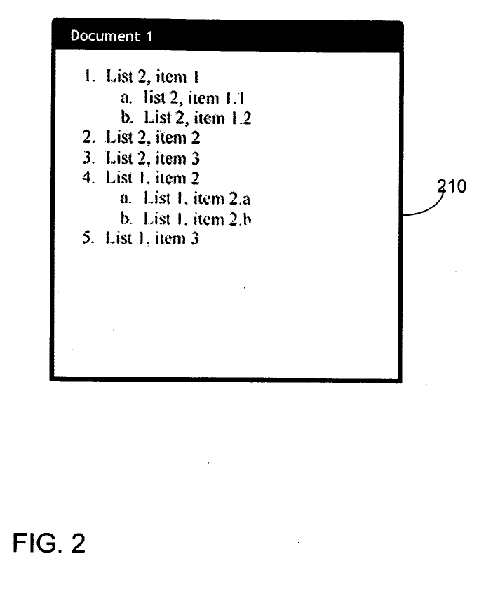

Turning now to FIG. 2, an example is given of a list in a file 210 that is being processed with a word processor. The list in file 210 illustrates the desired result of combining lists from files 110 and 112 as illustrated in FIG. 1. However, in this example, the entire list has a consistent formatting. Each element at the first level of the list begins with a sequentially ordered arabic numeral. Each element in each sublist at the second level of the list is indented by the same amount and begins with a lower case letter.

In the described embodiment, the list in document 210 is formatted automatically by the word processing application. The word processing application can select the appropriate formatting because it is operating in a constrained mode. In the constrained operating mode, the number of formatting options available for an outline numbered lists in document 210 is constrained. In this example, a single format for outline numbered lists is available.

With this constraint, regardless of the formatting specified for a list before it is inserted into document 210, the word processing application will apply a default format when the list is inserted into document 210. Unlike a default format in a traditional document template, the default format may be applied regardless of any formatting specified by other sources, such as in a template or in a style or by a user. The default format may also be applied regardless of how the list is inserted into the document. For example, the default formatting may apply when a user inputs the elements of the list using a keyboard, or the user inputs the list by copying text from another document and pasting it into document 210 or the user moves or copies text from another portion of the document 210.

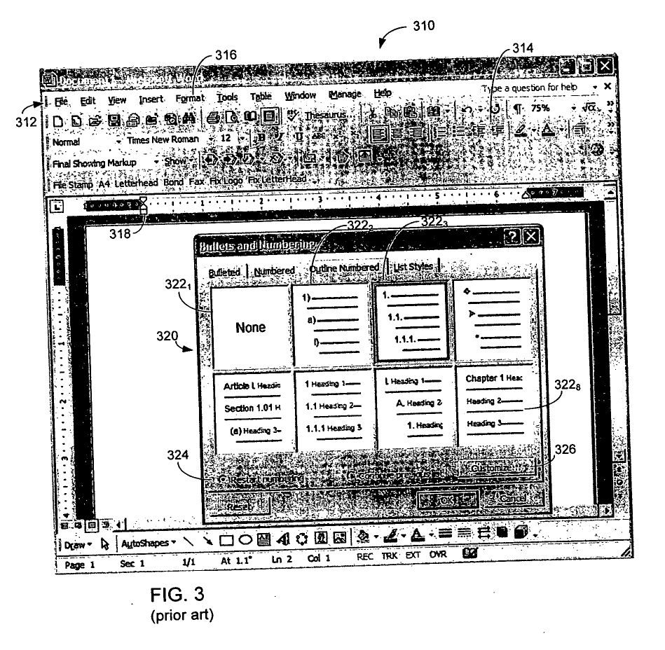

In one embodiment, user interfaces through which a user may specify formatting for the list are modified in constrained mode so that the user may not specify a format that is not permitted in constrained mode. FIG. 3 gives an example of a prior art user interface through which a user may specify that a selected block of text should be formatted as an outline numbered list.

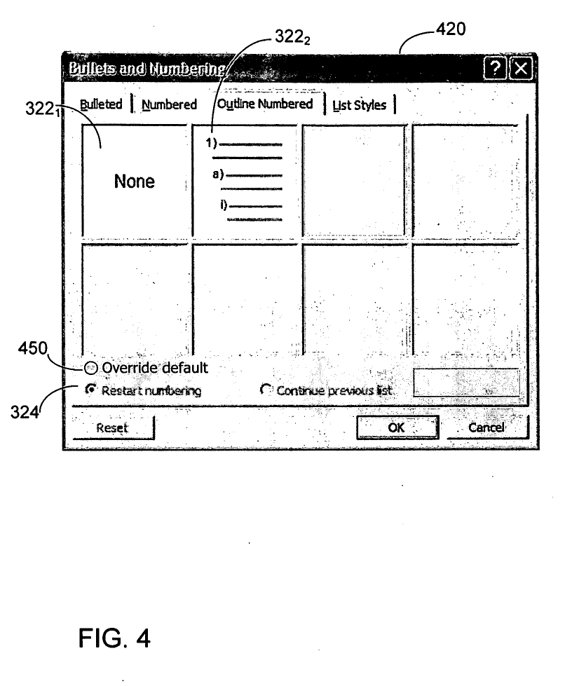

Such a user interface may be modified for use with a word processor that operates in a constrained mode in which formatting options for outline numbered lists are constrained to some subset of the total available formatting options. In addition, a user interface such as is illustrated in FIG, 3 may be used with a word processor that operates in a constrained mode if the word processor is also capable of operating in an unconstrained mode. In one embodiment, an interface as in FIG. 3 is presented to a user when a word processor operates in a unconstrained mode and a modified version of the interface, as illustrated in FIG. 4, is presented to the user when the word processor operates in a constrained mode.

In FIG. 3, the user interface is implemented as a display region 310 on the display of a computer running the word processor. Display region 310 contains controls that may be activated through a user input device. The user input device may be a mouse, a keyboard, a touchpad or other suitable user input device.

In the pictured example, the controls in display region 310 may be used to provide format command information to the word processor to impact how the word processor formats a list. Display region 310 also includes a menu bar 312 through that a user may invoke submenus containing commands that may allow specifying formatting of a list. In FIG. 3, menu bar 312 includes a menu choice 316 that brings up a menu from which a user may invoke a user interface for inputting formatting commands. One option on the menu may open dialog box 320.

Dialog box 320 provides a user interface for a user to provide commands specifying that a selected block of text should be formatted as a list, such as an outline numbered list. In this example, dialog box 320 contains multiple format options for an outline numbered list. Here, eight selection areas (only a portion of which are numbered for simplicity) provide the user with eight format options. Selection area 322₁, when selected, indicates that the selected text should not be formatted with outline numbering. Selection area 322₂, when selected, indicates that the selected text should be formatted with outline numbering as depicted in FIG. 2. Selection area 322₃, when selected, indicates that the numbering should have the formatting illustrated in document 112 (FIG. 1). The other selection areas (not numbered for simplicity) allow other formats to be selected.

If a user desires a format option not selectable through one of the selection areas, the user may specify a format using a further dialog box invoked when the customization control 326 is activated by the user.

The formatting specified through dialog box 320 defines attributes of the list, such as the type of characters used to identify successive entries at each level of the list and the difference in indenting between entries at different levels of the list.

Other controls specify how the format is applied to the selected block of text. For example, control 324 is a radio button control that specifies whether the selected text is a new list so that the first entry in the list should start with whatever value, usually one, that is reserved for the first entry in the list. Alternatively, control 324 may be used to specify that the selected text should be numbered as a continuation of a prior list.

Other information for applying the formatting may be input through other controls. For example, control 314 may be used to increase the level of selected text within a list. When the level within the list of selected text is changed, the indentation or numbering of that entry may change in accordance with the specified format for the list.

When the word processor is operating in a constrained mode, some of the controls in the display may be unnecessary. Controls, such as control 314 or numbering control 324 for specifying how the formatting is to be applied to specific blocks of text are still relevant for the user. However, in embodiments in which the user specification of a format does not override the default formatting, presenting formatting options other than those available as part of the default formatting may be undesirable. The user interface depicted in FIG. 3 may therefore be used in a modified form when the word processor is operating in a constrained mode.

FIG. 4 shows a dialog box 420 that the word processing application may present to a user while operating in a constrained mode. Dialog box 420 may be displayed to the user in the same fashion as dialog box 320 and may contain controls of the same type as are used in conventional word processors, whether now known or hereafter developed. Dialog box 420 differs from dialog box 320 in that dialog box 420 provides a reduced number of formatting selections consistent with the reduced number of formatting options available in constrained mode.

In this example, outline numbered lists are constrained to be in the format depicted in selection area 322₂. Accordingly, selection area 322₂ appears in the same way as in dialog box 320. Even in constrained mode, the user has the choice of not formatting selected text as a list at all. Accordingly, selection area 322₁, also appears in dialog box 420 in the same way that it appears in dialog box 320.

Other selection areas that represent formatting options are, in this example, not displayed for a user because the word processing application does not recognize those formatting options in constrained mode of operation. Similarly, customization control 326 does not appear in dialog box 420 because customized formatting is not permitted in the constrained mode of operation in this example.

Omitting the controls that could be used to specify formatting inconsistent with the allowed format options notifies the user that formatting options have been constrained. Other methods may alternatively be used to notify the user. For example, options available when the word processor is operating in a unconstrained mode may appear in dialog box 420 with a visual indicator that such options are not available. The options may, for example, be presented in a different color or with different shading to signify that such options are not available. Other types of indicators, including visual and audio indicators, may also be used.

Other controls available to a user when the word processor is operating in an unconstrained mode may also be disabled or omitted from user interfaces presented in constrained mode. Controls that could allow a user to specify formatting inconsistent with the default format may be omitted or modified such that do not operate when applied to a block of text formatted with the default format. For example, margin control 318 (FIG. 3) can, in a prior art word processor, be operated to change the indenting of lists. If the formatting of an outline numbered list is constrained, operation of margin control 318 could produce a list that does not have the constrained formatting. In embodiments where allowing a user to deviate from the default formatting in this fashion is not desired, such a control may be removed or disabled when a list is selected.

Though dialog box 420 presents a constrained list of formatting choices, controls that specify how the formatting is to be applied to specific blocks of text may still be presented to the user. For example, dialog box 420 includes a numbering control 324 in the same way that dialog box 320 includes such a numbering control. In addition, dialog box 420 may appear in a display area 310 as shown in FIG. 3. The display area may include additional controls, such as control 314 that alters the level in a list that is associated with a block of text.

Constraining the number of options for formatting a construct, such as an outline numbered list, can provide a user of a data processing application with a more user-friendly experience because it reduces the time the user must spend entering formatting commands. It also reduces the likelihood that components of the application that automatically apply formatting will apply an unintended format. However, constraining the number of formatting options also reduces the flexibility of the data processing application. To allow formatting inconsistent with the limited number of available formatting options, a control may be available to specify a further operating mode of the data processing application.

FIG. 4 illustrates a dialog box 420 for a word processing application that incorporates this mode of operation. In this embodiment, when formatting is constrained, a single formatting option is available, such as is illustrated by selection area 322₂. In this embodiment, any component of the word processor that applies formatting automatically will apply this format. However, to allow a user to specify a different format, a control 450 is included that overrides the default selection. When control 450 is activated by a user, a greater range of formatting options may be presented through dialog box 420. For example dialog box 420 may display all the options displayed in dialog box 320 or may allow access to a customization control such as customization control 326.

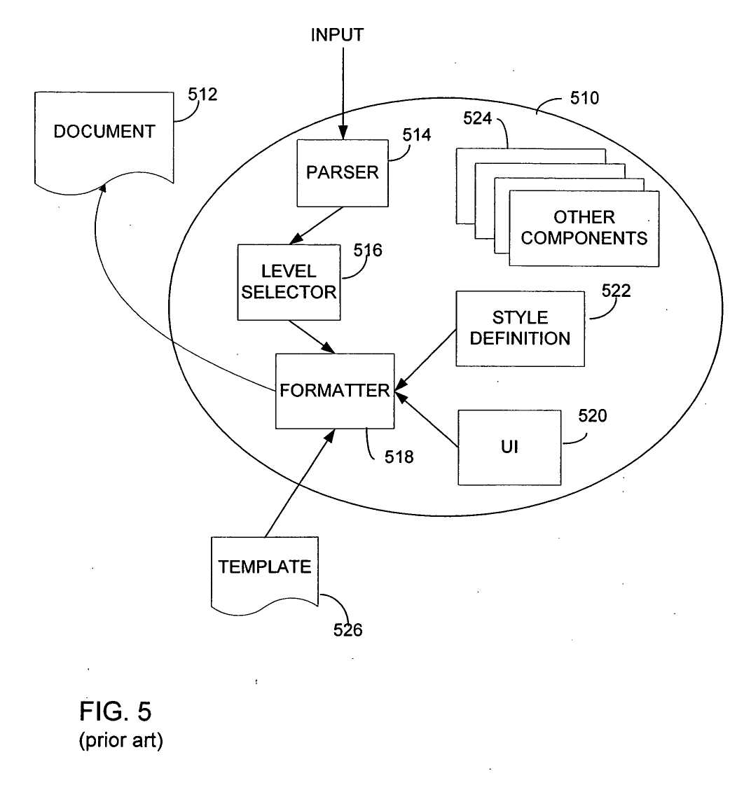

A word processor implementing a constrained mode of formatting may be implemented with technology conventionally used to construct a word processor or other data processing application. FIG. 5 gives an example of components within a word processor 510, which may be as is known in the art. Each of the components may be implemented in any suitable programming language and may be compiled into machine code compatible with the platform on which word processor 310 executes. These components may be DLL components, or may be implemented in any other suitable way.

In the example of FIG. 5, word processor 510 creates or edits document 512 in response to user commands, including commands that provide an input to be processed.

Word processor 510 includes a parser 514. As input is provided to word processor 510, parser 514 identifies constructs to which formatting may be applied.

Different format commands may operate on different constructs. For example, a selection of a font may operate on a block of text that contains one or more characters. Other format commands may operate on constructs such as lines of text. Still further formatting commands, such as those that format a list, operate on one or more consecutive paragraphs. Parser 514 is here described as recognizing a list because list formatting is being used to illustrate operation of a word processor that constrains formatting options. However, parser 514 may identify other constructs or word processor 510 may contain multiple parsers so that multiple constructs may be identified.

The input to parser 514 may come from any one of multiple sources. The input may be information typed by a user at a keyboard, information copied or moved from another location in the same document or information copied from another document, web service or any other source.

Parser 514 makes the block of text containing the identified construct available for further processing by other components. In the example of formatting a list, the block of text is provided to level selector 516. Level selector 516 identifies the portions of the block of text that represent entries at different levels of the list. As described above, controls such as control 514 may be used to specify that the level of certain elements of the list are at a higher level of the list. Level selector 514 aggregates the level information specified for each element in the block of text representing a list and attaches a level within the list to each element.

Formatter 518 operates on the block of text after list levels have been assigned. Formatter 518 determines the formatting to apply and formats the block of text as appropriate. In the example, formatter 518 may perform automatic formatting as new text is provided as an input to word processor 510. Alternatively, formatter 518 may perform formatting in response to a user command specifying that formatting should be applied to text in document 512. In the latter scenario, the input to word processor 510 is selected text within document 510.

Formatter 518 may apply format command information received from one or more sources. Format command information may be obtained from template 526. Template 526 may be a file stored in computer readable memory in a computer on which word processor 510 executes. Any suitable coding scheme may be used to record in template 526 information representative of format commands that are to be applied.

Alternatively, format command information may be obtained from a style definition component 522. Style definition component 522 may also include a file or other data store, which may be the same file as is used to store template 526. Style definition component 522 supplies format command information when the selected block of text has a style assigned to it. Format command information may also be specified through user interface component 520. User interface component 520 may generate a user interface as illustrated in FIG. 3 through which a user may input format commands.

When formatter 518 receives format command information from multiple sources, it selects format commands to apply. Once selected, format commands are applied to the selected block of text. The formatted block of text is then written to document 512.

Word processor 510 also includes other components 524 that perform other functions of a word processor. For simplicity, the other components 524 are not individually shown or described, but such components are known in the art.

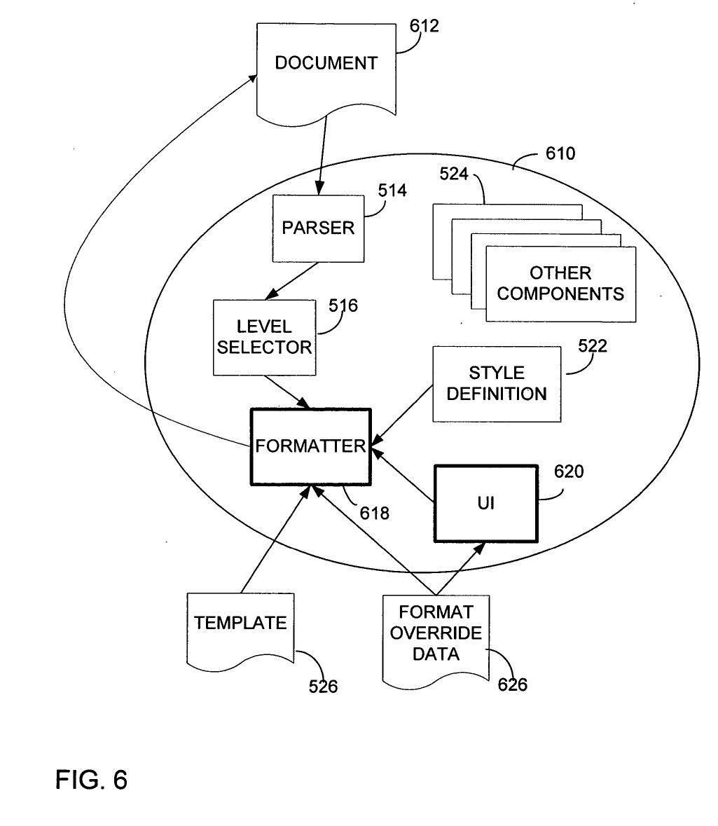

A word processor capable of operating in a constrained mode may be implemented using many components that are known in the art. FIG. 6 provides a comparable block diagram of word processor 610 that can operate in a constrained mode. In this example, word processor 610 may also operate in a mode that allows a user to specify any one of a large selection of formats for lists or other constructs. Accordingly, word processor 610 includes a template 526 and a style definition component 522 as in word processor 510.

Word processor 610 differs from word processor 510 in that it includes modified components that ignore some sources of format information when word processor 610 is operating in a constrained mode. For example, formatter 618 ignores format command information from template 526 or style definition component 522 when operating in a constrained mode. Similarly, user interface 620 is modified to present only choices available in constrained mode when operating in a constrained mode. In the illustrated embodiment, the formatting choices available in constrained mode are specified by information stored in artifact 626.

A word processor may enter constrained mode in any number of ways. In the illustrated embodiment, word processor 610 may automatically enter constrained mode when artifact 626 is present. When artifact 626 contains formatting command information for a particular construct, the formatting commands in artifact 626 are applied regardless of other format command information in a template 526 or provided by style definition component 322.

Similarly, word processor 610 includes a modified user interface component 620. User interface component 620 displays a user interface that provides a user with formatting options consistent with those available in constrained mode. User interface component 620 obtains information about the available formatting options from artifact 626. For example, user interface component 620 may display a dialog box, such as dialog box 420, with a reduced number of choices in comparison to those offered through dialog box 320 (FIG. 3).

Other components of word processor 610 that operate differently depending on the number of formatting options may similarly be replaced with components that process only the reduced number of format options specified in artifact 626.

The components in word processor 610 that operate on a reduced number of format options may be created in any suitable way, including using technology and coding practices as used to create comparable components in prior art word processors. Such components may be readily incorporated into a prior art word processor by using DLL components that replace the comparable components that process a full range of possible formatting options. Any suitable technique may be used to replace one set of components with another. Examples of programming techniques that may be used in include inheriting the level of the level of an existing component or subclassing the prior component.

In one embodiment, the components that process a reduced number of formatting options consistent with a constrained mode of operation are included as part of the word processing application, but are dynamically linked into the executable version of the word processor only when the constrained mode is entered. In this way, the same set of computer-executable instructions can be provided to multiple users and customized for those that want to operate the word processor in constrained mode.

When the word processing application is constructed from multiple components that are dynamically linked, the word processor can be customized to implement a desired mode of operation at any suitable time. For example, the word processor may be customized at the time it is installed. If customized at time of installation, the specific components activated in the word processor may be based on user input of a desired operating mode. Alternatively, the word processor may be customized subsequent to installation. Such a customization may, for example, be based on the user attaching artifact 626 to the word processor. As another alternative, the components that are used in the word processor may be selected while the word processor is executing. The desired components may, for example, be selected in response to user input specifying a desired mode of operation.

Other ways for causing word processor 610 to operate in one of multiple possible modes are possible. The components that process reduced numbers of formatting options to implement a constrained mode may be constructed to also process format options not specified in artifact 626. Such processing may, for example, be appropriate if word processor 610 is designed to allow users to select whether to operate in constrained mode or to allow a user to selectively override constrained mode. Multiple modes of operation may be desirable, for example, if an override control, such as control 450, is available.

Artifact 626 may be implemented as any suitable data store. For example, artifact 626 may be a file stored on a computer on which word processor 610 operates. However, artifact 626 may be a file stored on any computer to which word processor 610 has access while executing. It is not necessary that artifact 626 be a traditional file. Artifact 626 may be any source of information, such as information streamed by a web service in response to a request for information.

Artifact 626 may be associated with word processor 610 in any suitable way. For example, word processor 610 may be programmed to recognize a file with a specific name or file type as artifact 626. Word processor 610 may be programmed to search specific locations in the directory structure on the computer on which it operates to find a file with a specific name or file type. Alternatively, the name of the file may be specified at the time of installation of word processor 610 or when the file is created. Where artifact 610 is implemented as a remote file or remote web service, the address for such a data store may be provided in any suitable way at the time of installation of the word processor or at a later time when the word processor is customized to operate in a constrained mode.

As a further alternative, artifact 626 may be created or associated with a copy of word processor 610 in an automated fashion. For example, word processor 610 may include a component that receives user input of formatting to use in constrained mode and creates artifact 626 storing the format command information needed to apply such formatting.

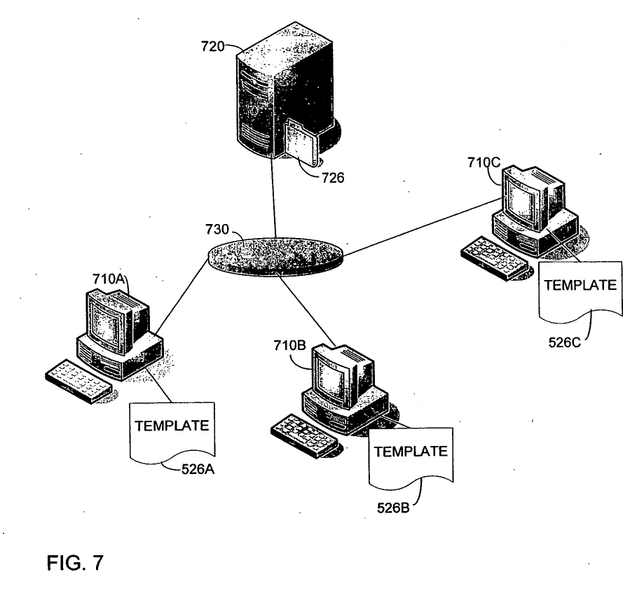

A word processor that operates in a constrained mode may be used in many settings. FIG. 7 shows how a word processor, such as word processor 610, may be beneficially employed in an enterprise in which multiple people process documents. In FIG. 7, the enterprise is shown to have multiple work stations, of which work stations 710A, 710B, 710C are shown.

Each of the work stations may be used by an individual within the enterprise to process documents or other data using a data processing application that may be operated in a constrained mode. Each of the work stations 710A, 710B and 710C includes a template 526A, 526B, 526C, respectively. Such templates may be associated with the data processing application and are illustrative of one source of formatting command information for the data processing application. Other formatting command information may be provided through a user interfaces associated with the work stations 710A, 710B and 710C or may be provided in any other suitable way.

The work stations 710A, 710B and 710C are connected through network 730 to a server 720. Server 720 has a data store 726 associated with it. Data store 726 may be implemented in any suitable way, such as on a disk drive or other computer-readable medium. Data store 726 holds one or more artifacts that specify a limited number of formatting options available when the data processing applications executing on work stations 710A, 710B and 710C are operated in a constrained mode.

In the embodiment of FIG. 7, multiple work stations within the enterprise access the same data store for information about constrained formatting choices. In this way, documents created by different individuals on different work stations can have consistent formatting. As multiple individuals, possibly using multiple work stations, share documents, confusion associated with inconsistent formatting command information from multiple sources can be avoided. In addition to providing consistent looking documents across the enterprise, the embodiment of FIG. 7 reduces the time that individuals within the enterprise spend formatting and reformatting documents when others in the organization have worked on them.

Having thus described several aspects of at least one embodiment of this invention, it is to be appreciated that various alterations, modifications, and improvements will readily occur to those skilled in the art.

For example, it was described above that an enterprise contains multiple work stations, each running a copy of a word processor. Constrained formatting may be used even if all or a portion of the application that performs the formatting is running on a processor other than the computer work station. For example, the enterprise may employ one or more applications that includes a server programmed to create or edit document in response to commands received from a user.

Further, it is described that an artifact stores information prescribing a limited number of formatting options available when a data processing application is operated in a constrained mode. A specific example of formatting applied to an outline numbered list was provided. A similar approach may be applied to provide constrained formatting options for other constructs. Where constrained formatting is desired for many constructs, an artifact specifying formatting options available for each construct may be provided. Alternatively, formatting options for many constructs may be provided in the same artifact. Similarly, a separate formatter may be provided for each construct or one formatter may be modified to format multiple constructs in a constrained mode. Likewise, one user interface component may be used to provide a user interface in constrained mode to receive formatting command information for each construct or one user interface component may be provided to receive format command information for multiple constructs.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, the invention may be embodied as a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiment.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-readable medium having computer-executable components comprising:
a first component for receiving input from a user;
a second component for recognizing a construct in the input from the user;
a third component for applying formatting to the construct, the third component operable in a first mode in which formatting is applied by automatically selecting a formatting rule from a plurality of sources and in a second mode in which formatting is applied by selecting a default formatting rule despite formatting rules specified in the plurality of sources.

2. The computer-readable medium of claim 1, wherein the computer-executable components implement a word processing application.

3. The computer-readable medium of claim 2, wherein the construct is a numbered list.

4. The computer-readable medium of claim 1, additionally comprising a fourth component for displaying formatting options to the user, the fourth component operable in the first mode to display a first number of formatting options and in the second mode to display a second number of formatting options, the second number less than the first number.

5. The computer-readable medium of claim 1, wherein the second component recognizes lists in the input from the user.

6. The computer-readable medium of claim 1, wherein the plurality of sources comprises a formatting rule in a template file and a formatting rule associated with the input received from the user.

7. The computer-readable medium of claim 6, additionally comprises a data store holding the default formatting rule.

8. In a computer system having a graphical user interface including a display and a user input device, the computer system executing a data processing application that operates on an artifact having one or more blocks of text, a method comprising the steps of:
a) receiving a user format request input;
b) in a first mode of operation, in response to the user format request input:
i) displaying a plurality of formatting options;
ii) receiving user selection input indicating one of the plurality of formatting options;
iii) formatting a block of text according to the indicated formatting option; and
c) in a second mode of operation, in response to the user format request input:
i) displaying a first of the plurality of formatting options with an indication that it is the default formatting option; and
ii) formatting a block of text according to the first of the plurality of formatting option.

9. The method of claim 8, additionally comprising, in the second mode of operation, displaying a default over-ride control.

10. The method of claim 9, additionally comprising, in response to an indication that the user activated the default over-ride control, switching from the second mode to the first mode.

11. The method of claim 9, additionally comprising, in response to an indication that the user activated the default over-ride control, while in the second mode of operation, formatting a second block of text according to one of the plurality of formatting options other than the first.

12. The method of claim 8, wherein
step b(i) comprises displaying a dialog box having a plurality of selection areas, each selection area indicating an associated formatting option; and
step c(i) comprises displaying the dialog box with a portion of the plurality of selection areas altered in appearance to indicate the associated formatting option is not available.

13. The method of claim 12, wherein each of the plurality of selection areas displays a formatting option for an outline numbered list.

14. An enterprise data processing system comprising:
a plurality of work stations, each having an associated document and a source of work station specific formatting information;
a data store holding an enterprise-wide formatting template;
a network connecting each of the plurality of work stations to the data store, for each of the plurality of work stations, at least one data processing application program executable from the work station, the data processing application comprising a component for applying formatting to at least one construct in the associated document according to a formatting specified in the enterprise-wide formatting template when the data processing application program operates in a first mode or the associated work station specific formatting information when the data processing application operates in a second mode.

15. The enterprise data processing system of claim 14, wherein the data processing application comprises a word processor.

16. The enterprise data processing system of claim 14, wherein the at least one construct comprises a block of text to be formatted as an outline numbered list.

17. The enterprise data processing system of claim 14, wherein:
the at least one data processing application program executable from each of the plurality of work stations comprises a plurality of copies of the data processing application program, each installed on one of the plurality of work stations; and
each of the plurality of work stations comprises computer-readable media and the work station specific formatting information comprises a template for each of the plurality of work stations stored in the computer-readable media of the work station.

18. The enterprise data processing system of claim 14, additionally comprising a web service making the enterprise wide formatting template available to each of the work stations over the network.

19. The enterprise data processing system of claim 14, wherein the component applies formatting according to user formatting input commands when the data processing application operates in a third mode.

20. The enterprise data processing system of claim 19, wherein the data processing application comprises a component that provides a user interface including a control and the data processing application enters the third mode when the a user activates the control.
